(19) United States
(12) Patent Application Publication
(10) Pub. No.: US 2018/0310596 A1
(43) Pub. Date: Nov. 1, 2018

(54) AIR POPCORN POPPER

(71) Applicant: C. Cretors & Company, Wood Dale, IL (US)

(72) Inventors: Charles D. Cretors, Venice, FL (US); Nenad Vidojevic, Chesterton, IN (US)

(21) Appl. No.: 15/499,580

(22) Filed: Apr. 27, 2017

(51) Int. Cl. A23L 5/10; A23L 7/161

(52) U.S. Cl. CPC A23L 5/17; A23V 2002/00; A23L 7/161

(57) ABSTRACT

Popcorn machines having fan assemblies and heat sources are described herein. The fan assemblies and the heat sources can be configured to provide heat to unpopped corn kernels to produce popcorn without the use of cooking oil. The popcorn machines can be configured for commercial use and can be mounted onto support structures that allow operators to rotate the popcorn machines. In some embodiments, the operator rotates the popcorn machine about an axis that extends parallel to the rotational axis of the fan assembly. In these embodiments, rotating the popcorn machine while the fan is rotating does not induce substantial stress on the fan assembly due to the rotational inertia of the fan.

### APPLICATIONS INCORPORATED BY REFERENCE

U.S. application Ser. No. 13/866,981, titled “AIR POPCORN POPPER” and filed Apr. 19, 2013, and U.S. Provisional Application No. 61/635,805, titled “AIR POPCORN POPPER” and filed Apr. 19, 2012, are incorporated herein by reference in their entireties.

### TECHNICAL FIELD

The following disclosure relates generally to commercial popcorn machines utilizing heated air to pop corn kernels and associated devices and methods.

### BACKGROUND

Commercial popcorn vendors typically employ popcorn machines that heat unpopped kernels in a bath of oil. The resulting popcorn can retain a significant portion of the cooking oils, leading to increased oil consumption by consumers who eat popcorn prepared this way. This comes as nutritional experts have increasingly recommended that foods high in fat be reduced or even eliminated from one's diet. Furthermore, without added oils, popcorn can be a very nutritional food, as it contains relatively high levels of fiber and antioxidants.

Air popping corn kernels is one method of applying a sufficient amount of heat to unpopped kernels to produce popcorn without the use of added oils. However, typical consumer air popping machines are designed for home use and are not robust or large enough for commercial use (e.g. in a concession stand). Moreover, typical air popping machines lack the ability regulate the heat applied to the corn kernels (e.g., by controlling an amount of current supplied to a heating element, an amount of airflow into the popping machine, etc.) to compensate for variations in, for example, corn kernel varieties and/or ambient conditions. There exists a need for a commercial-grade air popping machine with a temperature and/or airflow intake adjustment capability.

### BRIEF DESCRIPTION OF THE DRAWINGS

FIGS. 1A and 1B are a front isometric view and a front view, respectively, of a popcorn machine configured in accordance with an embodiment of the present disclosure.

FIGS. 2A and 2B are rear isometric views of the popcorn machine of FIGS. 1A and 1B configured in accordance with an embodiment of the present disclosure.

FIG. 3 is a rear isometric view of the popcorn machine of FIGS. 1A and 1B with a cover assembly removed for clarity in accordance with an embodiment of the present disclosure.

FIG. 4A is a detail front view of the popcorn machine of FIG. 1B, configured in accordance with an embodiment of the present disclosure.

FIG. 4B is a cross-sectional side view of the popcorn machine of FIG. 4A, configured in accordance with an embodiment of the present disclosure.

FIG. 5 is an isometric view of a heating element configured in accordance with an embodiment of the present disclosure.

FIG. 6 is a side view of the popcorn machine of FIGS. 1A and 1B illustrating a mode of operation in accordance with an embodiment of the present disclosure.

FIGS. 7A and 7B are front and rear isometric views, respectively, of a popcorn machine configured in accordance with another embodiment of the present disclosure.

FIGS. 8A and 8B are a partially cut away front isometric view and a front cross-sectional view, respectively, of the popcorn machine of FIGS. 7A and 7B configured in accordance with an embodiment of the present disclosure.

### DETAILED DESCRIPTION

The following disclosure describes various embodiments of air popping popcorn machines and associated devices and methods. In some embodiments, the popcorn machines described herein include a cabinet pivotally mounted to a support structure so that the cabinet can be rotated downwardly by an operator to facilitate removal of, for example, unpopped corn kernels and/or other byproducts of the corn popping process from the machine. The popcorn machines can further include an air heating assembly that includes an electric motor coupled to a fan (e.g., a centrifugal fan). The air heating assembly is configured to draw air into the machine from the surrounding air space and heat the air to a sufficient temperature to pop corn kernels and produce popcorn. In one aspect of these embodiments, the rotational axis of the electric motor and the fan is oriented parallel to the pivot axis of the popcorn machine cabinet. As described in greater detail below, orienting these axes so that they are parallel to each other prevents detrimental inertial forces from being applied to the components of the fan assembly (e.g., the motor drive shaft) during rotation of the popcorn machine cabinet, thereby greatly reducing the operational stress placed on the drive shaft and the related components and greatly reducing machine downtime for maintenance or replacement of fan system components.

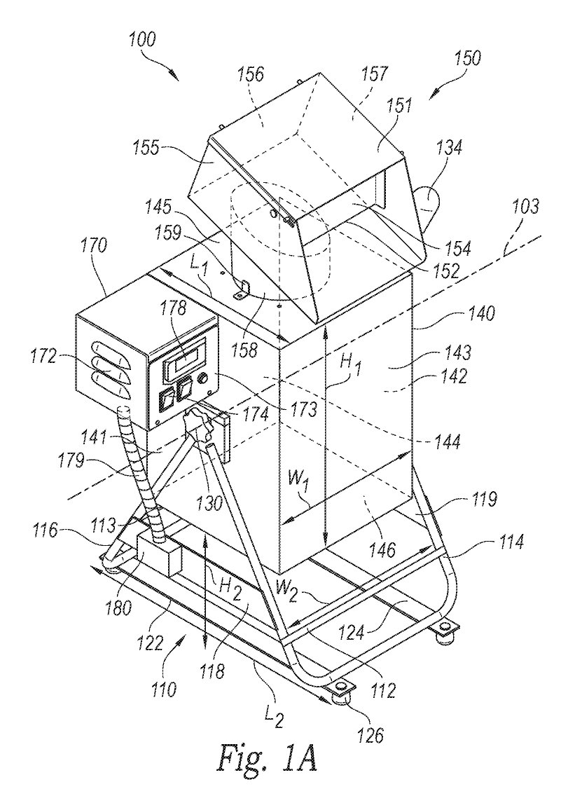

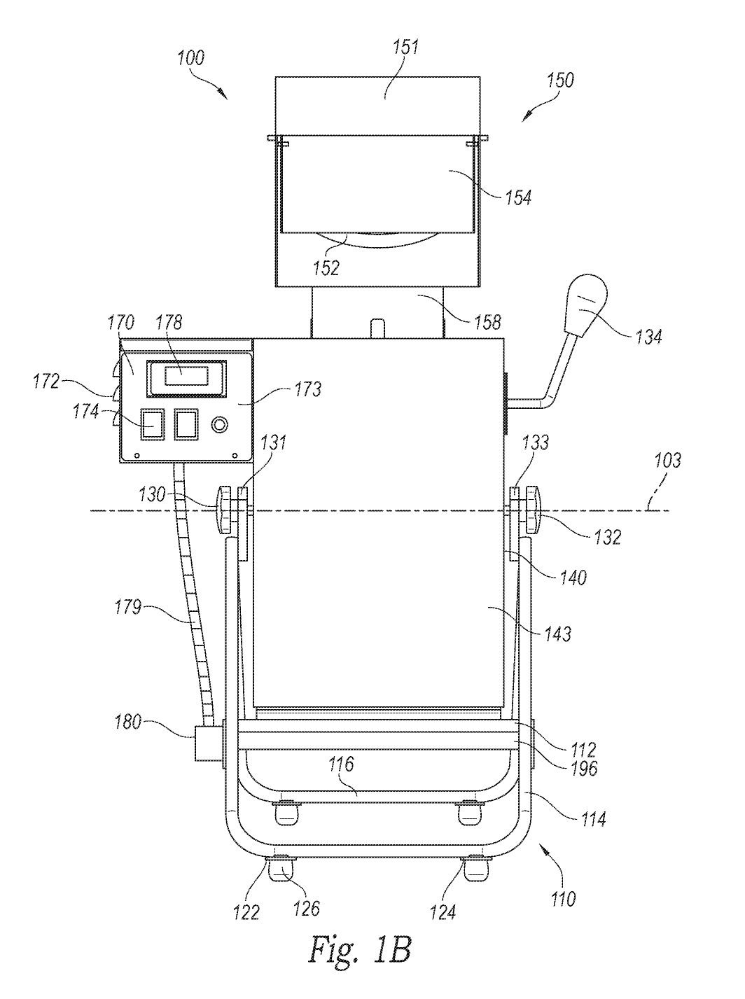

Certain details are set forth in the following description and in FIGS. 1A-8B to provide a thorough understanding of various embodiments of the disclosure. Those of ordinary skill in the relevant art will appreciate, however, that the technology disclosed herein can have additional embodiments that may be practiced without several of the details described below and/or with additional features not described below. In addition, some well-known structures and systems often associated with popcorn machines and methods of making popcorn have not been shown or described in detail below to avoid unnecessarily obscuring the description of the various embodiments of the disclosure.

The dimensions, angles, features, and other specifications shown in the figures are merely illustrative of particular embodiments of the disclosure. Accordingly, other embodiments can have other dimensions, angles, features, and other specifications without departing from the scope of the present disclosure. In the drawings, identical reference numbers identify identical, or at least generally similar, elements.

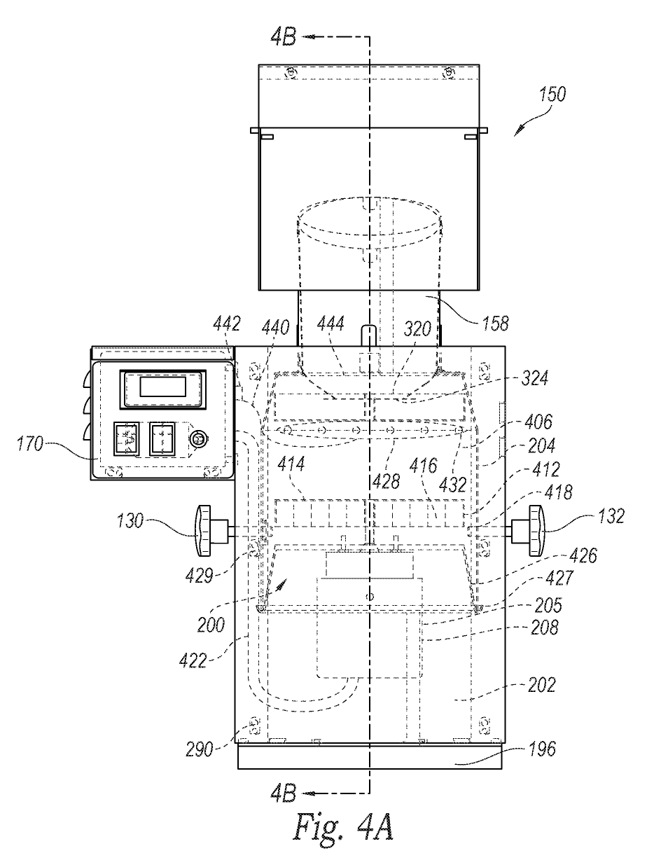

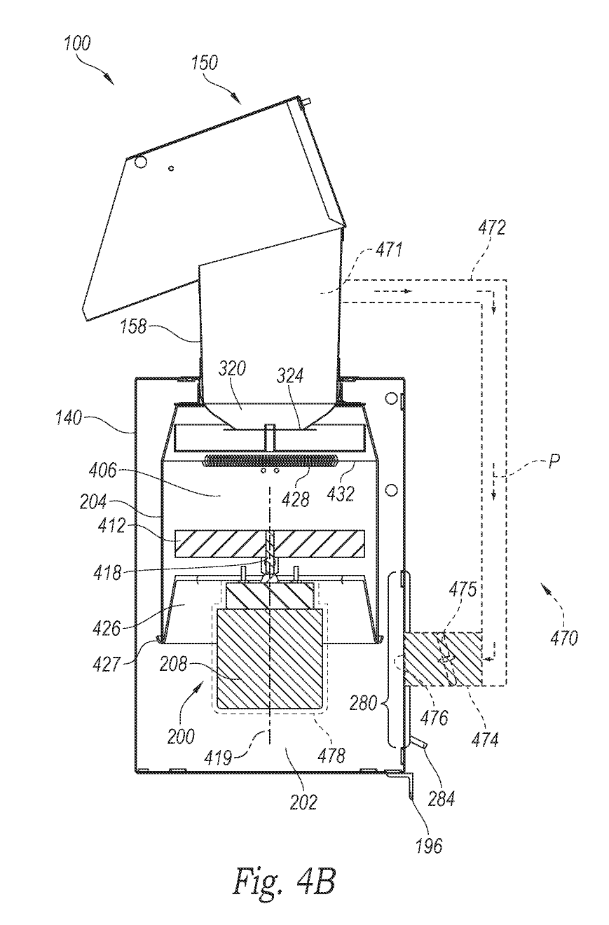

FIGS. 1A and 1B are a front isometric view and a front view, respectively, of a popcorn machine 100 configured in accordance with the present disclosure. Referring to FIGS. 1A and 1B together, in the illustrated embodiment, many features of the popcorn machine 100 can be at least generally similar in structure and function to corresponding features of popcorn machines described in U.S. application Ser. No. 12/890,370, which is incorporated herein in its entirety by reference. The popcorn machine 100 includes a shell or cabinet 140 that houses an air heating assembly (discussed in more detail below with reference to FIGS. 4A and 4B), a support structure or frame 110, a lid assembly or cover 150, and an electrical control unit 170.

The cabinet 140 can be made from any suitable durable, heat-resistant material (e.g. sheet metal, such as aluminum, stainless steel, etc.) and can include a pair of opposing side walls 141 and 142, a front wall 143 opposite a removable rear panel 144, and a top wall 145 opposing a bottom wall 146. In the illustrated embodiment, the front wall 143 and rear panel 144 have a height H₁ (e.g., 10 inches to 24 inches, or approximately 15 inches) and a width W₁ (e.g., 8 inches to 20 inches, or approximately 12 inches). The side walls 141 and 142 have a length L₁ (e.g., 8 inches to 20 inches, or approximately 12 inches) and height H₁. The top wall 145 and the bottom wall 146 have a length approximately equal to L₁ and a height approximately equal to H₁. In other embodiments, however, H₁, W₁ and L₁ can include any suitable dimension. Moreover, in the illustrated embodiment, the cabinet 140 has a generally rectangular shape, but in other embodiments, the cabinet 140 may have any suitable shape (e.g. a cube, a trapezoidal solid, and/or a sphere).

The frame 110 is configured to support the cabinet at a height H₂ (e.g., 5 inches to 15 inches, or approximately 8 inches) and includes two U-shaped support structures 114 and 116 fixedly attached to one another by a pair of junction plates 131 and 133, a pair of side braces 118 and 119, and a pair of support rails 122 and 124 having a length L₂ (e.g., 10 inches to 30 inches, or approximately 18 inches). A front crossbar 112 and an opposing rear crossbar 113 extend a width W₂ (e.g., 8 inches to 16 inches, or approximately 12 inches) across the support structures 114 and 116, respectively, to limit rotation of the cabinet 140. In some embodiments, however, H₂ and W₂ can include any suitable dimension. Moreover, in the illustrated embodiment, the support rails 122 and 124 rest on one or more feet 126. In other embodiments, the support rails 122 and 124 may rest on, for example, casters, height-adjustable legs, etc.

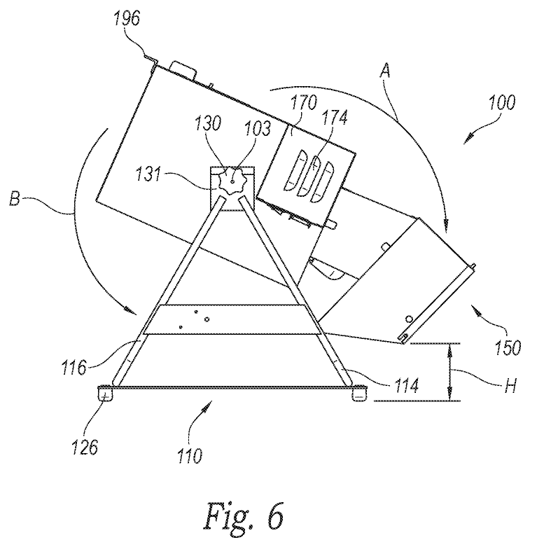

The frame 110 is coupled to the cabinet 140 by a pair of operable bearings 130 and 132. In the illustrated embodiment, the bearings 130 and 132 each include a knob rigidly attached to an end portion (e.g., a threaded rod). The bearings 130 and 132 are inserted through the junction plates 131 and 133, respectively, into receptacles (e.g. threaded holes, through holes, etc.) in the side walls 141 and 142, respectively configured to receive the bearings 130 and 132. An operator may, for example, turn the respective knobs of the bearings 130 and 132 to adjust the degree by which the junction plates 131 and 133, respectively, press against the respective side walls 141 and 142 to apply friction thereto. Loosening the bearings 130 and 132, for example, can allow the cabinet 140 to pivot about an axis 103 aligned with the bearings 130 and 132 and rotate forward when an operator, for example, pulls downwardly on a handle 134 attached to the side wall 142. Conversely, tightening the bearings 130 and 132 can press the junction plates 131 and 133 against the side walls 141 and 143, thereby restricting the ability of the cabinet 140 to rotate. In some embodiments, an operator may loosen and/or tighten the bearings 130 and 132 using, for example, nuts inserted onto the end portions of the bearings 130 and 132. An L-shaped bracket or bumper 196 is fixedly attached to an underside surface of the bottom wall 146 to limit rotation of the cabinet 140 from the orientation shown in FIGS. 1A and 1B. The rotational operation of the popcorn machine 100 is discussed in more detail below with reference to FIG. 6.

In the illustrated embodiment of FIGS. 1A and 1B, the frame 110 can be a base structure supporting the cabinet 140. However, in other embodiments, the cabinet 140 can be similarly supported from other structures by a frame in other orientations. For example, in some embodiments, the frame 110 can be configured to be mounted, for example, in a housing or cabinet, and/or on one or more side walls or ceiling thereof, to allow the cabinet 140 to rotate during operation as explained above.

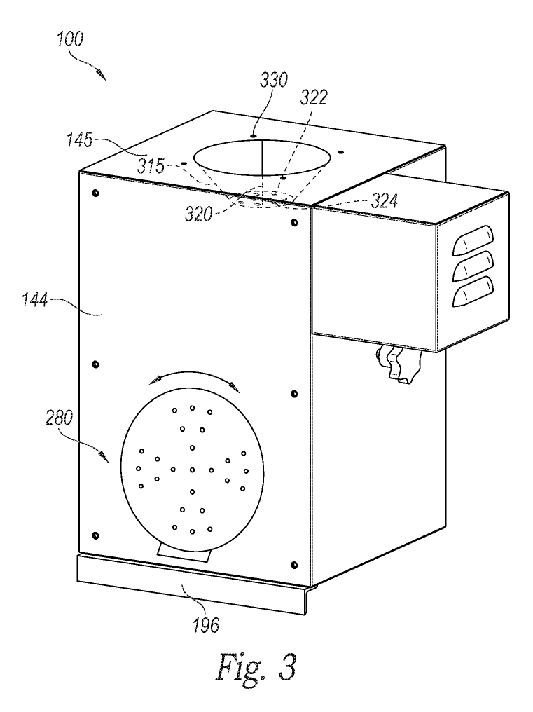

The cover 150 includes a lid 151, an opening 152, a pivotable shield 154, and a duct 158 fixedly attached to the top wall 145 by one or more fasteners 159. The cover 150 also includes a pair of opposing side panels 155 and 157 and a rear panel 156. During operation, an operator loads the popcorn machine 100 by pouring unpopped kernels through the opening 152, the duct 158, and into a popcorn holding area (discussed in detail below with reference to FIG. 3). The explosive nature of an unpopped kernel becoming a piece of popcorn can cause other unpopped kernels and popcorn to fly wildly and unpredictably. The shield 154, however, which hangs pendant from the top of the opening 152, helps to contain the unpopped kernels and popcorn within the popcorn machine 100 during popping operation until a bed of popped kernels expands through the opening 152 and pushes out of the cover 150 past the shield 154.

An electrical box or control unit 170 having one or more vents 172 is disposed on the side wall 141. The control unit 170 can include a control panel 173 having one or more controls 174 (e.g. buttons, switches, knobs, etc.) and one or more displays 178 (e.g., light emitting diodes (LEDs), liquid crystal displays (LCDs), touchscreen displays, etc.). The control unit 170 is electrically coupled to a power input box 180 via a conduit 179. The power input box 180 can receive external electrical power from a power cord (not shown) plugged into a power source to provide electrical power to the control unit 170.

A user can operate various components of the popcorn machine 100 via the control panel 173. For example, in operation, a user can press a Start Button when the user is ready to begin heating of unpopped corn kernels. Pressing the Start Button can initiate a variety of functions on the popcorn machine 100. For example, as discussed in more detail with reference to FIG. 4A, one or more heating elements can be energized and a fan can be activated to begin heating the corn kernels. The control unit 170 can also be configured to automatically complete various operations of the popcorn machine 100. For example, the control unit 170 can adjust the power to the one or more heating elements after a predetermined amount of time and/or when a predetermined temperature has been reached (e.g., as measured by a thermocouple). The control unit 170 can also, for example, provide an indication on the display 178 that a popping cycle is complete. In some embodiments, for example, the control unit 170 can also adjust a temperature in response to user input. For example, the user can choose a popping cycle and/or temperature based on a list of popcorn varieties that the control unit 170 presents to the user via the display 178. Based on a selected variety of popcorn and a measured temperature, the control unit 170 can adjust an amount of power to the heating element accordingly to provide sufficient heat to the unpopped kernels.

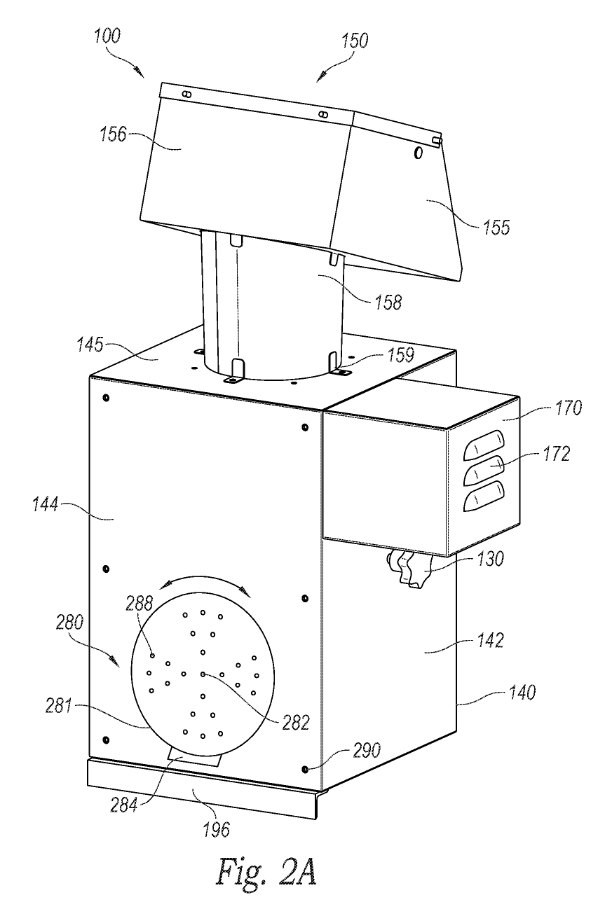

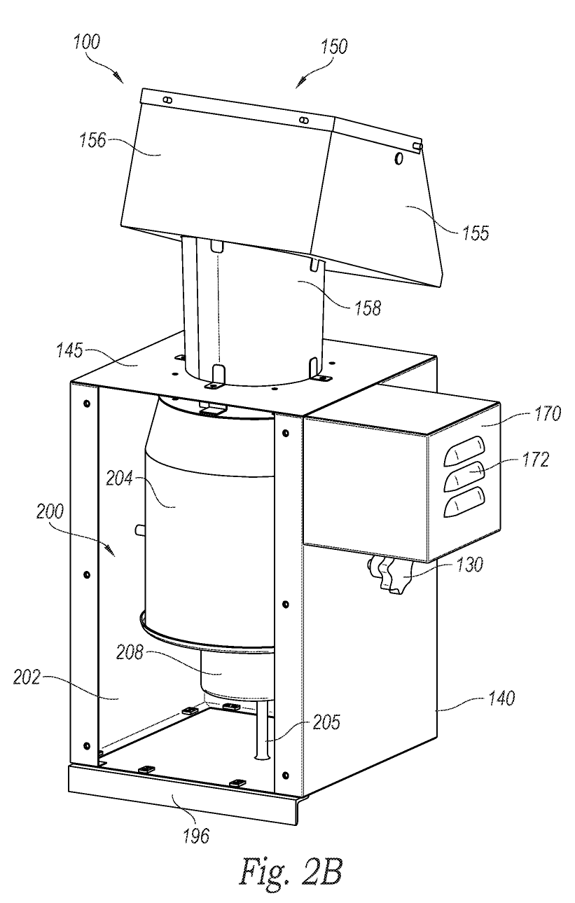

FIGS. 2A and 2B are rear isometric views of the popcorn machine 100 with the rear panel 144 attached and removed, respectively. In FIG. 2A, the rear panel 144 is removably attached to the cabinet 140 by one or more rear panel fasteners 290 (e.g., screws, clips, bolts, etc.) An air inlet 280 can include, for example, an air intake regulator or rotatable metal disc 281. The disc 281 includes a plurality of apertures 288 and can rotate about a spindle 282 when force is applied to a handle 284 (e.g., by an operator). A portion of the rear panel behind the disc 281 can have, for example, inlet holes generally similar in size and pattern as the apertures 288. Rotation of the disc 281 can regulate the amount of air drawn through the inlet 280 into an interior cavity 202 (FIG. 2B) of the cabinet 140 by adjusting a percentage of the surface area of the inlet holes of the rear panel open to external airflow. As those of ordinary skill in the art would appreciate, an increase in the open area of the inlet holes is generally proportional to an increase in the amount of heat that the popcorn machine 100 can produce. In some embodiments, for example, air intake regulation may be performed by another device other than the disc 281. For example, an operable louver, a damper, and/or a slidable shutter may be employed in and/or on the inlet 280 instead of the disc 281.

Referring to FIG. 2B, the cavity 202 is an interior space inside of the cabinet 140 in which an air heating assembly 200 is positioned. As explained in more detail below with reference to FIGS. 4A and 4B, the air heating assembly 200 includes a motor 208 coupled to a fan (not shown) surrounded by a protective cover or shroud 204 and supported by one or more legs 205. The air heating assembly 200 is configured to draw in air from the surrounding airspace into the cavity 202 and heat the air to a sufficient temperature to heat unpopped kernels to produce popcorn.

FIG. 3 is a rear isometric view of the popcorn machine 100 with the cover 150 removed, configured in accordance with an embodiment of the present disclosure. In the illustrated embodiment, a kernel holding area, receptacle or bowl 320 extends downward from an opening 315 in the top wall 145. The bowl 320 includes a base portion 322 having a plurality of apertures 324 therein. A plurality of holes 330 in the top wall 145 can each receive one of the fasteners 159 to facilitate attachment of the duct 158 to the cabinet 140 (FIG. 1A). During operation of the popcorn machine 100, a user inserts unpopped kernels into the cover 150 (not shown). The unpopped kernels are deposited in and/or on the bowl 320. The user may then activate the air heating assembly 200 to produce and discharge heated air through the apertures 324 in the bowl 320, thereby heating the unpopped kernels. If and/or when the air heating assembly 200 produces air having a sufficient temperature (e.g. 400-460 degrees Fahrenheit or 200-240 degrees Celsius), the popcorn machine 100 can heat the unpopped kernels to produce popcorn. The popcorn can then exit the popping machine via the opening 152 in the cover 150 (FIGS. 1A and 1B).

FIG. 4A is a detail view of the popcorn machine 100, configured in accordance with an embodiment of the present disclosure. FIG. 4B is a cross-sectional side view of FIG. 4A along the denoted 4B line in FIG. 4A. In the illustrated embodiment of FIGS. 4A and 4B, the motor 208 is electrically coupled to the control unit 170 via one or more wires 422, configured to transmit, for example, electrical power and/or control signals. An upper portion of the motor 208 is at least partially surrounded by a circular inner base 426, which includes a circular lip 427 (FIG. 4B) on which the shroud 204 may rest. The inner base 426 further includes a top surface or fan support 429 configured to support an air mover or fan 412 thereon. A spindle 418 rotationally couples the fan 412 to the motor 208. In the embodiment of FIG. 4A, the fan 412 is a centrifugal fan having a plurality of blades 414 circumferentially arranged to form a plurality of fan outlets 416. Additionally, the motor 208 rotates the fan 412 about an axis 419 that is collinearly aligned with the spindle 418 and is oriented at 90 degrees (i.e. perpendicular), or at least approximately 90 degrees, to the pivot axis 103 of the cabinet 140. In other embodiments, however, the fan 412 may be any suitable fan and/or air mover (e.g., an axial fan).

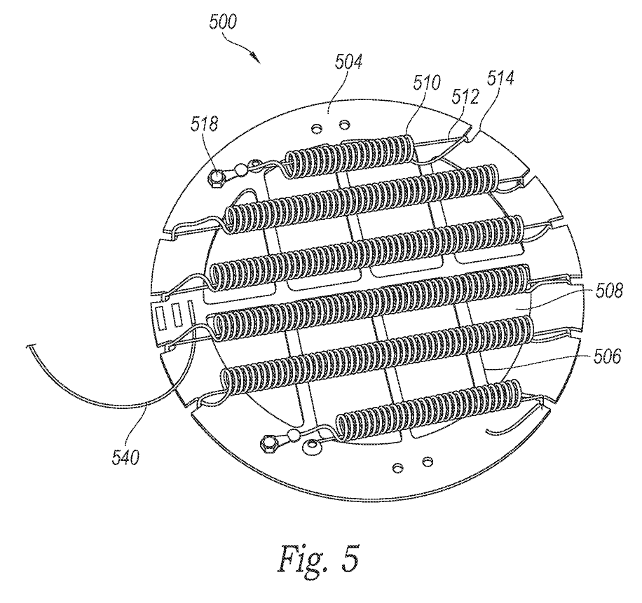

A heat element 428 is fixedly attached to an upper portion of the shroud 204 and is configured to be placed within the cavity at least proximate to an underside surface of the base portion 322 of the bowl 320 (FIG. 3). As described in more detail below with reference to FIG. 5, the heat element 428 can include one or more coils 432 configured produce heat when an electric current is applied therethrough. The heat element 428 can be electrically coupled to the control unit 170 by one or more wires 440, which can be configured to provide, for example, electrical power and/or control signals to the heat element 428.

Upon activation (e.g., when a user depresses a Start button on the control unit 170), the control unit 170 can supply electric power to the heat element 428 and the motor 208. As the motor 208 drives the fan 412 via the spindle 418, air is drawn through a center opening in the underside of the fan 412 (not shown) and discharged through the fan outlets 416 into a fan cavity 406 surrounded by the shroud 204. The discharged air flows upwardly in the fan cavity 406 and through the heat element 428. The heated air further flows into the bowl 320 before continuing out of the popcorn machine 100 through the cover 150. A wire 442 can electrically couple a thermocouple 444 disposed in and/or on the bowl 320 to the control unit 170. The thermocouple 444 can provide, for example, temperature data to be shown on display 178. A protective cover or motor shroud 478 may be employed to at least partially protect and/or insulate the motor 208 from the heat of the incoming recirculated air.

In some embodiments, for example, the popcorn machine 100 can include a recirculating system 470 configured to recover heat from air escaping the popcorn machine 100 via the cover 150 (e.g., through the use of a heat exchanger) and/or reuse the escaping heated air. Reusing escaping air may offer several advantages, such as, for example, reducing the amount of electrical energy needed to heat air in the popcorn popper and reducing the amount of heated air discharged in the space surrounding the popcorn machine 100. In the illustrated embodiment of FIG. 4B, for example, an outlet 471 in a rear portion of the duct 158 can be coupled to the air inlet 280 via a recirculation duct 472. In some embodiments, a fan assembly 474 including a fan 475 can be disposed at least proximate the inlet 280 to draw escaping air along a path P into the cavity 202 of the cabinet 140 via an outlet 476. In other embodiments, however, the fan assembly 474 may be installed in another suitable position on the cabinet 140. The fan assembly 474 can include, for example, one or more filters to remove, for example, byproducts of corn popping operations from the reused air.

In some other embodiments, however, the recirculation system 470 may include the recirculation duct 472 without the fan assembly 474 and the fan 475. In one or more of these embodiments, for example, a pressure differential between a first pressure (e.g., an ambient pressure, standard atmospheric pressure, etc.) at the outlet 471 popper and a second pressure (e.g., a negative pressure less than the ambient pressure) at the inlet 280 can cause at least a portion of air escaping the cover 150 to flow into the duct 472 and into the cavity 202 toward the fan 412. Accordingly a portion of the heated air that may be typically discharged from the machine 100 can be returned to the fan 412, thereby reclaiming at least a portion of the heat previously produced by, for example, the heat element 428.

FIG. 5 is an isometric view of a heating element 500, configured in accordance with an embodiment of the present disclosure. The heating element 500 includes a metal plate 504 having a grid 506 supporting one or more metal coils 510. In the illustrated embodiment, the grid 506 includes one or more open areas or gaps 508 through which air may flow during operation of the popcorn machine 100. The coils 510 may be fixedly attached to the heating element by at least one end by a hook 514 attached at one of a plurality of notches 512 in the metal plate 504. The coils 510 may also be attached to the metal plate 504 by a fastener 518 (e.g. a screw, a clip, etc.). A lead or wire 540 electrically couples the heating element to the control unit 170 (FIGS. 1A and 1B) to provide, for example, electrical power to the heating element 500. During operation of the popcorn machine 100, the fan 412 (FIGS. 4A and 4B) discharges air, which flows through the heating element 500 and is heated by the coils 510. If a sufficient amount of heat (e.g. 400-460 degrees Fahrenheit) is produced by the heating element 500, unpopped kernels in the bowl 320 may begin to pop, thereby producing popcorn.

FIG. 6 is a side view of the popcorn machine 100 showing rotational operation thereof. The popcorn machine 100 is shown in FIG. 6 after forward rotation about the axis 103 in the direction of arrow A caused by, for example, an operator downwardly pulling the handle 134. The cover 150 is configured to engage the front crossbar 112 to limit forward rotation of the popcorn machine 100 such that the cover 150 is generally at least a height H above the floor on which the popcorn machine 100 is placed. The operator may wish to rotate the popcorn machine 100 forward as shown in FIG. 6 to, for example, empty the popcorn machine 100 of unpopped kernels and/or other byproducts of the corn popping process. The operator can the restore the popcorn machine 100 to its standard upright orientation by pulling upward on the handle 134, thereby moving the popcorn machine 100 in the direction of arrow B until the bumper 196 engages the rear crossbar 113.

As explained above in reference to FIGS. 1A and 1B, the frame 110 can be a base structure supporting the cabinet 140. However, in other embodiments, the cabinet 140 can be similarly supported from other structures by a frame in other orientations. For example, in some embodiments, the frame 110 can be configured to be mounted, for example, in a housing or cabinet, and/or on one or more side walls or ceiling thereof, to allow the cabinet 140 to rotate during operation as explained above.

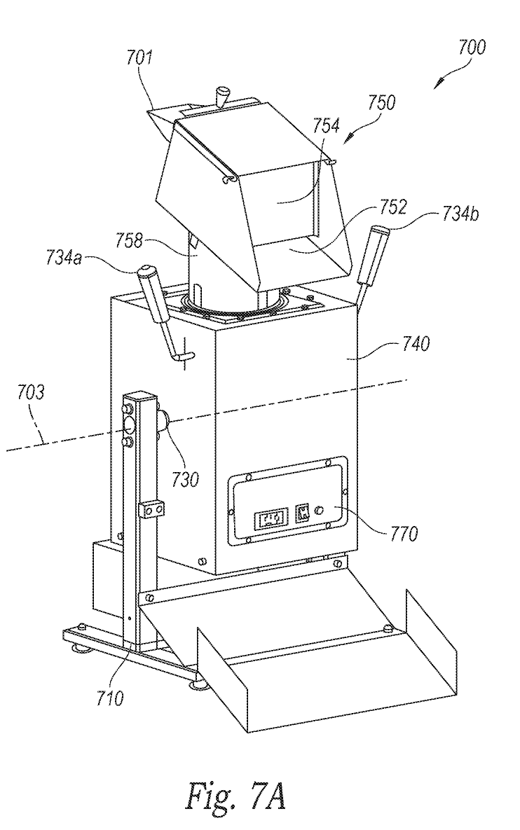

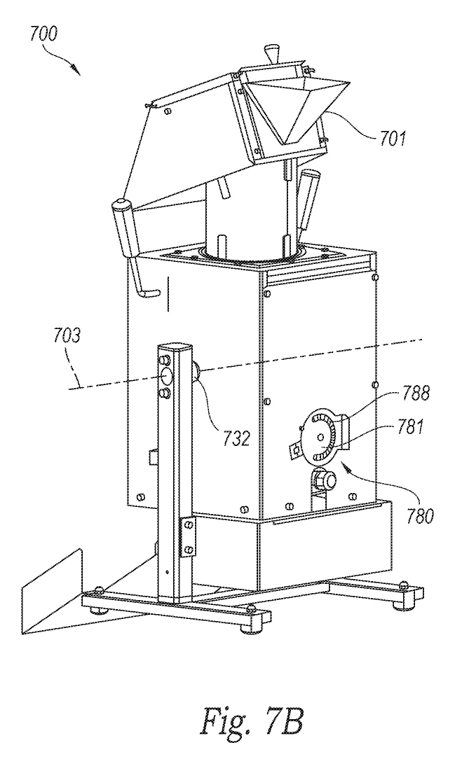

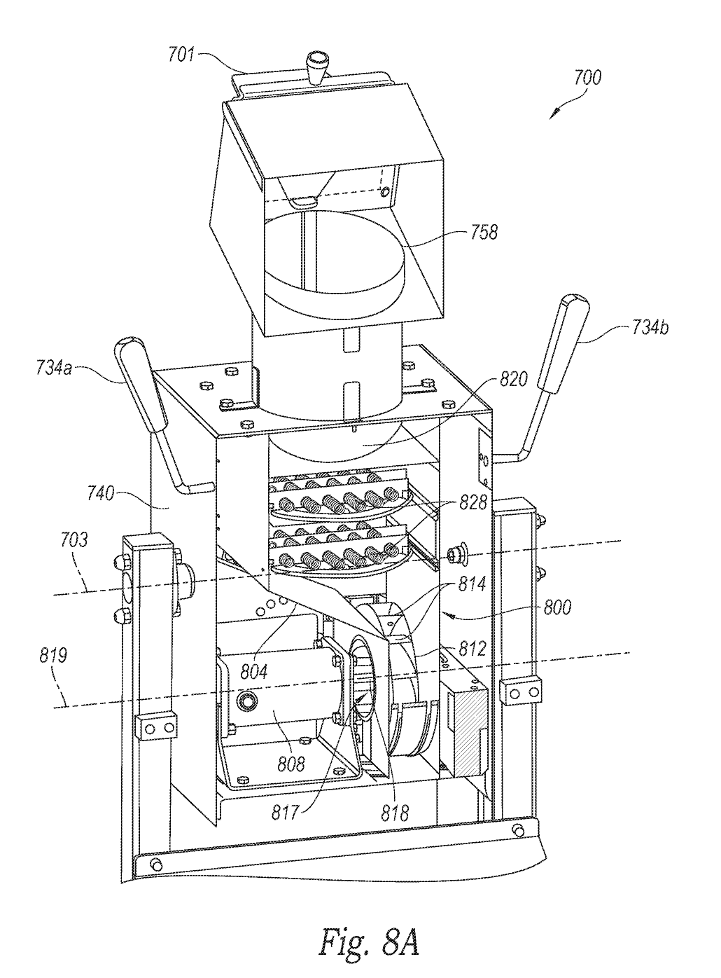

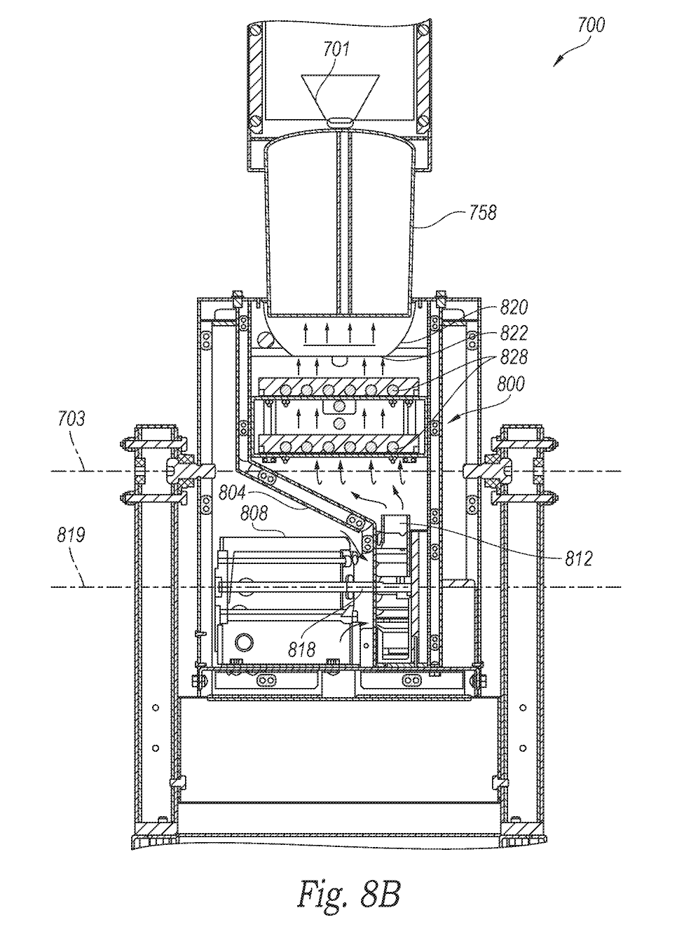

FIGS. 7A and 7B are front and rear isometric views, respectively, of a popcorn machine 700 configured in accordance with another embodiment of the present disclosure. Referring to FIGS. 7A and 7B together, the popcorn machine 700 is at least generally similar in structure and function to the popcorn machine 100 described in detail above with respect to FIGS. 1A-6. Indeed, many of the structures and functions of the popcorn machine 700 can be identical, or at least substantially similar, to the corresponding structures and functions of the popcorn machine 100. For example, in the illustrated embodiment the popcorn machine 700 includes a shell or cabinet 740 that houses an air heating assembly (described in more detail below with reference to FIGS. 8A and 8B), a support structure or frame 710, a lid assembly or cover 750, and an electrical control unit 770. The cabinet 740 is pivotally mounted to opposing uprights of the frame 710 by means of rotational bearings 730 and 732. Handles 734a, b are mounted to opposite sides of the cabinet 740 to facilitate rotation of the cabinet 740 about the pivot axis 703 by an operator.

Like the popcorn machine 100 described in detail above, the cover 750 of the popcorn machine 700 is operably coupled to the cabinet 740 by means of a duct 758. Additionally, the cover 750 includes a pivotable shield 754 that hangs pendant in front of an opening 752. In this particular embodiment, the cover 750 further includes an inlet 701 on a rear portion thereof that provides a passage for introducing unpopped corn kernels into the heating assembly via the duct 758. In operation, the shield 754 can help contain unpopped corn kernels and popped corn within the popcorn machine 700 until a bed of popped corn expands through the opening 752 and pushes out of the cover 750 past the shield 754. As shown in FIG. 7B, an air inlet 780 can be mounted to a rear panel of the cabinet 740 and can include, for example, an air intake regulator or rotatable metal disc 781. The disc 781 includes a plurality of openings or apertures 788 and can rotate about a central spindle to regulate the amount of air drawn into the cabinet 740 via the aperture 788.

In the illustrated embodiment, the control unit 770 is operably disposed on a front panel of the cabinet 740, and can have one or more controls (e.g., buttons, switches, knobs, etc.) and/or one or more displays (e.g., LEDs, LCDs, touch screen displays, etc.) to facilitate user inputs for control of the popcorn machine 700. The control unit 770 can receive electrical power from a suitable power cord (not shown) connected to a suitable power source (e.g., facility power) to provide electrical power for operation of the popcorn machine 700.

FIGS. 8A and 8B are a partially cutaway front isometric view and a front cross-sectional view, respectively, of the popcorn machine 700 configured in accordance with an embodiment of the present disclosure. In FIG. 8A, front portions of the cabinet 740 and the cover 750 have been omitted for purposes of illustrating an air heating assembly 800 which is positioned within an interior space of the cabinet 740. Referring to FIGS. 8A and 8B together, the air heating assembly 800 includes a motor 808 (e.g., an electric motor) having a spindle 818 (which can also be referred to as a drive shaft) extending outwardly therefrom and operably coupled to a fan 812. In the illustrated embodiment, the fan 812 is a centrifugal fan having a plurality of blades 814 (also known as impellers) extending outwardly from a central hub that is mounted to a distal end portion of the spindle 818.

In the illustrated embodiment, the spindle 818 and the fan 812 revolve about a rotational axis 819 that is oriented parallel to the pivot axis 703 of the cabinet 740. The fan 812 is housed in a shroud 804 that encloses a lower portion of the fan 812 and extends upwardly and outwardly to enclose a plurality of heat elements 828. Each of the heat elements 828 can be generally similar in structure and function to the heat element 428 described in detail above with reference to FIGS. 4A and 4B, except in the illustrated embodiment the popcorn machine 700 can include two of the heat elements 828 spaced apart from each other and arranged vertically in the cabinet 740 beneath a bowl 820. Like the bowl 320 described above with reference to FIG. 3, the bowl 820 includes a perforated base portion 822 that enables heated air to flow upwardly from the heat elements 828 and into the bowl 820 for heating unpopped kernels placed therein.

Operation of the popcorn machine 700 is at least generally similar to operation of the popcorn machine 100 described in detail above. For example, the user can pour a desired amount of unpopped corn kernels into the inlet 701. From the inlet 701, the corn kernels fall through the duct 758 and land in the bowl 820. The user can then activate the air heating assembly 800 by depressing a Start button or other activation switch on the control unit 770 (FIG. 7A) and the control unit 770 can supply electric power to the heat elements 828 and the motor 808. As the motor 808 drives the fan 812, the fan 812 receives air from the interior of the cabinet 740 via a central (e.g., circular) opening 817 in the shroud 804. The opening 817 introduces the air into the nearside of the fan blades 814, and the fan blades 814 turn the air 90 degrees and accelerate it outwardly via the outer periphery of the blades 814. The shroud 804 around the fan 812 then directs the flowing air upwardly through the heat elements 828 and through the perforated base portion 822 of the bowl 820 to heat and pop the corn kernels positioned therein (as described above with reference to, for example, FIG. 3). The popped corn then exits the popcorn machine 700 via the opening 752 in the cover 750 (FIG. 7A). As described above with reference to FIG. 6, the user can pull the handles 734a and/or 734b to rotate the popcorn machine 700 forward and downwardly about the pivot axis 703 to, for example, empty the popcorn machine 700 of unpopped kernels and/or other byproducts of the corn popping process. The operator can then restore the popcorn machine 700 to its upright orientation by rotating one or more of the handles 734a, b upwardly.

In one aspect of the illustrated embodiment, the reader will note that the rotational axis 819 of the electric motor 808 and the fan 812 is oriented so that it extends parallel to the pivot axis 703 of the cabinet 740. In contrast, the motor 208 and the fan 412 of the popcorn machine 100 described above (see, for example, FIG. 4B) are positioned to operationally rotate about an axis 419 that extends perpendicularly to (i.e., at 90 degrees relative to) the pivot axis 103 of the popcorn machine 100. The inventor has recognized that, in operation of the popcorn machine 100, the user will often rotate the cabinet 140 about the pivot axis 103 while the motor 208 and the fan 412 are rotating at a relatively high rate. This rotation of the cabinet 140 also necessarily rotates the motor 208 and the fan 412 about the pivot axis 103. However, because the rotational axis 419 of the motor spindle 418 and the fan 412 (FIG. 4B) is perpendicular to the pivot axis 103, rotating the cabinet 140 about the pivot axis 103 exerts a substantial torque on the spindle 418 as a result of the angular inertia of the fan 412. More specifically, as the cabinet 140 is rotated about the pivot axis 103, it applies a torque to the motor spindle 418 to change the angular momentum of the fan 412. The resistance of the fan 412 to the change of angular momentum creates a substantial bending load and related stresses on the motor spindle 418 and associated motor and fan hardware, which the inventor has found may lead to premature part wear and malfunction that may require higher than normal maintenance or replacement.

The popcorn machine 700 described above with reference to FIGS. 7A-8B advantageously overcomes these shortcomings because the motor 808 and fan 812 are positioned to operate on a rotational axis 819 that extends parallel to the pivot axis 703. As a result, when the cabinet 740 is rotated about the pivot axis 703 while the fan 812 is still spinning, the rotation of the cabinet 740 has no, or a negligible, effect on the angular momentum of the fan 812 and, as a result, imposes little or no stress on the motor spindle 818. Accordingly, orienting the rotational axis 819 of the fan 812 so that it is parallel to the pivot axis 703 can advantageously result in higher service life and require less maintenance and/or part replacement than other embodiments in which the fan/motor axis is oriented perpendicular (or at another angle) relative to the pivot axis of the cabinet.

The foregoing description of embodiments of the invention is not intended to be exhaustive or to limit the disclosed technology to the precise embodiments disclosed. While specific embodiments of, and examples for, the invention are described herein for illustrative purposes, various equivalent modifications are possible within the scope of the invention, as those of ordinary skill in the relevant art will recognize. For example, although certain functions may be described in the present disclosure in a particular order, in alternate embodiments these functions can be performed in a different order or substantially concurrently, without departing from the spirit or scope of the present disclosure. In addition, the teachings of the present disclosure can be applied to other systems, not only the representative popcorn machine devices and methods described herein. Further, various aspects of the invention described herein can be combined to provide yet other embodiments.

All of the references cited herein are incorporated in their entireties by reference. Accordingly, aspects of the invention can be modified, if necessary or desirable, to employ the systems, functions, and concepts of the cited references to provide yet further embodiments of the disclosure. These and other changes can be made to the invention in light of the above-detailed description. In general, the terms used in the following claims should not be construed to limit the invention to the specific embodiments disclosed in the specification, unless the above-detailed description explicitly defines such terms. Accordingly, the actual scope of the disclosure encompasses the disclosed embodiments and all equivalent ways of practicing or implementing the disclosure under the claims.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below,” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

From the foregoing, it will be appreciated that specific embodiments of the disclosed technology have been described herein for purposes of illustration, but that various modifications may be made without deviating from the invention. Certain aspects of the disclosure described in the context of particular embodiments may be combined or eliminated in other embodiments. Further, while advantages associated with certain embodiments of the disclosed technology have been described in the context of those embodiments, other embodiments may also exhibit such advantages, and not all embodiments need necessarily exhibit such advantages to fall within the scope of the disclosed technology. Accordingly, the disclosure and associated technology can encompass other embodiments not expressly shown or described herein. The invention is not limited, except as by the claims.

1. A popcorn machine, comprising:
a frame;
a cabinet pivotally mounted to the frame about a pivot axis;
a perforated receptacle positioned in an upper portion of the cabinet;
a cover assembly attached to the upper portion of the cabinet, wherein the cover assembly includes a passage configured to receive unpopped corn kernels for deposit into the receptacle, and wherein the cover assembly further includes an opening configured to allow popped corn kernels to exit the machine therethrough;
a heat source positioned in the cabinet beneath the perforated receptacle; and
a fan positioned in the cabinet and configured to revolve about a rotational axis to move air past the heat source and through the perforated receptacle to pop the corn kernels therein, wherein the cabinet is configured to rotate about the pivot axis to move the cover assembly from a first height above the floor to a second height above the floor, less than the first height, to facilitate movement of popcorn out of the cabinet through the opening, and wherein the rotational axis of the fan is parallel to the pivot axis of the cabinet.

2. The popcorn machine of claim 1 wherein the rotational axis of the fan is horizontal, and wherein the heat source, the perforated receptacle, and the cover are positioned in vertical path extending upward from the rotational axis.

3. The popcorn machine of claim 1 wherein the fan is positioned in a lower portion of the cabinet, and wherein the rotational axis of the fan is spaced apart from the pivot axis of the cabinet.

4. The popcorn machine of claim 1, further comprising an electric motor having a spindle operably coupled to the fan, wherein the spindle has a rotational axis that is parallel to the rotational axis of the fan and the pivot axis of the cabinet.

5. The popcorn machine of claim 1, further comprising an electric motor having a spindle, wherein the fan includes a blade arrangement mounted to the spindle, and wherein the spindle has a rotational axis that is collinear to the rotational axis of the fan.

6. The popcorn machine of claim 1 wherein the fan is a centrifugal fan having a blade arrangement rotatably positioned within a shroud, wherein the popcorn machine further comprises an electric motor having a spindle extending through an opening in the shroud and operably coupled to the fan blade arrangement, wherein rotation of the blade arrangement via the electric motor draws air into the fan blades via the opening and drives the air outwardly from the periphery of the fan blades into the shroud and toward the heat source.

7. The popcorn machine of claim 1 wherein the fan is configured to move air past the heat source and through the perforated receptacle to pop the corn kernels in the absence of cooking oil.

8. The popcorn machine of claim 1 wherein the opening in the cover assembly is a first opening, and wherein the cover assembly further includes a second opening, spaced apart from the first opening and leading to the passage.

9. The popcorn machine of claim 1 wherein the opening in the cover assembly is a first opening positioned on a front portion of the cover assembly, and wherein the cover assembly further includes a second opening leading to the passage and positioned on a rear portion of the cover assembly.

10. The popcorn machine of claim 1 wherein the heat source includes a first heating element having a first plurality of coils configured to produce heat when electric current is applied therethrough, and a second heating element spaced apart from the first heating element and having a second plurality of coils and configured to produce heat when electric current is applied therethrough.

11-15. (canceled)
